(19) United States
(12) Patent Application Publication
(10) Pub. No.: US 2009/0181825 A1
(43) Pub. Date: Jul. 16, 2009

(54) RELEASING SYSTEM WITH CONSISTENT STROKE UTILIZING WEAR AND TEAR COMPENSATION

(75) Inventors: Josef Bader, Friedrichshafen (DE); Andreas Graf, Stockach-Wahlwies (DE); Karl-Fritz Heinzelmann, Meckenbeuren (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/300,145

(22) PCT Filed: Apr. 25, 2007
(86) PCT No.: PCT/EP2007/054016

§ 371 Date: Nov. 10, 2008

(30) Foreign Application Priority Data
May 13, 2006 (DE) 10 2006 022461.2

(51) Int. Cl. B60W 10/02; F16D 25/08

(52) U.S. Cl. 477/180; 192/70.252

(57) ABSTRACT

A release system (1) for a clutch and/or an accelerating coupling (2) in a motor vehicle, which automatically compensates for wear on the clutch and/or accelerating coupling (2). The release system (1) includes of a piston-cylinder unit (24), which is arranged concentrically with a transmission input shaft (12) and features a cylinder (13) and two pistons (14, 17) that delimit two pressure chambers (16, 19). The piston-cylinder unit is controlled both pneumatically and hydraulically.

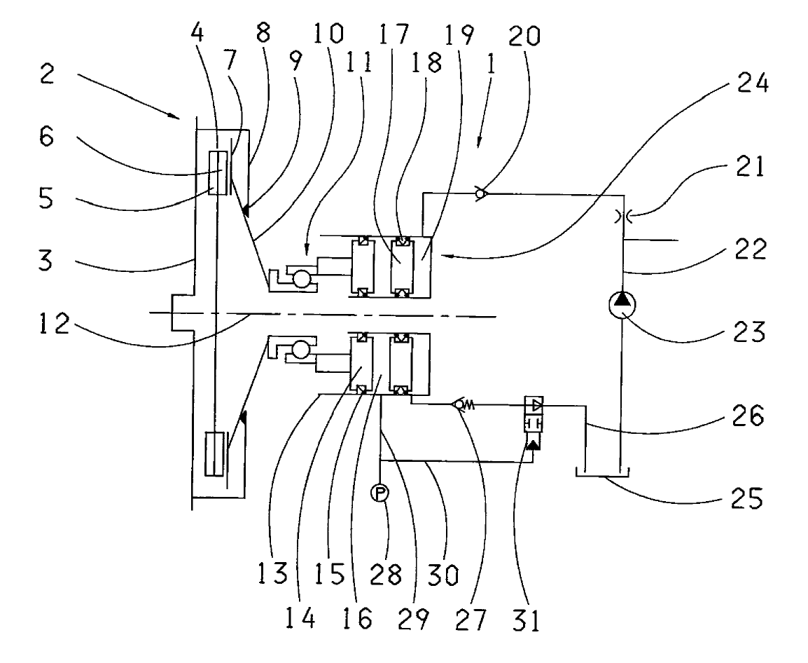

This application is a national stage completion of PCT/EP2007/054016 filed Apr. 25, 2007, which claims priority from German Application Serial No. 10 2006 022 461.2 filed May 13, 2006.

### FIELD OF THE INVENTION

The invention relates to a releasing system for controlling a clutch and/or an acceleration coupling in a motor vehicle.

### BACKGROUND OF THE INVENTION

A clutch and/or an acceleration coupling, which may be configured as a friction clutch, is an element of a motor vehicle drive train that is subjected to great strain. Even though the quality and lifetime of clutch linings have improved considerably, they are subject to operational wear even when used sparingly. A reduction in the thickness of the clutch lining influences the position of a clutch spring, for example a membrane or disk spring, such that a releasing force or a contact force and thus also the necessary pedal force, increase. In the state of the art, friction clutches and releasing systems are described that automatically compensate for clutch lining wear.

DE 44 07 665 B4 discloses a hydraulically actuatable releasing system for a motor vehicle friction coupling. The releasing system consists of a piston-cylinder unit arranged concentrically to an incoming gear shaft, whose cylinder is affixed to the transmission housing. A piston is arranged inside the cylinder, whose lateral surface is at least partially encompassed by a guiding element. A preloading spring arranged on the releasing system serves to hold the release bearing of the releasing system in contact with the contact spring of the friction clutch. Through a retaining mechanisms for the guiding element, the guiding element functions as a stationary component during the inward and outward movement of the piston. The guiding element is initially forced to perform an axial movement when, with wear on the friction linings of the friction clutch, the piston is pushed deeper into the cylinder chamber by the contact spring of the friction clutch. The effect of the retaining mechanism is thereby canceled and the guiding element is displaced by an axial distance until the change in position of the contact spring of the friction clutch is compensated for. As soon as a new balance of forces has been established, the guiding element comes to a stop. On the basis of this new position of the guiding element, the piston performs its inward movement with the usual piston stroke, where its stroke path is displaced in an axial direction compared to the stroke path of a clutch that is as good as new.

The object of the present invention is to disclose a releasing system for controlling a clutch and/or an acceleration coupling in a motor vehicle, by way of which clutch wear can be securely and simply compensated for and which can be manufactured with little complexity of manufacturing technique.

### SUMMARY OF THE INVENTION

A releasing system for a clutch and/or an accelerating coupling in a motor vehicle consists of a piston-cylinder unit, arranged concentrically to a transmission input shaft. The clutch and/or accelerating coupling is configured as a friction clutch, which can show wear over its lifetime. The piston-cylinder unit features a cylinder and two pistons, such that two pressure chambers in the cylinder are bounded. The cylinder can be arranged on a transmission housing. The first piston of the piston-cylinder unit serves as a working piston, where the second piston of the piston-cylinder unit represents a final position of the releasing system. The friction clutch is operated by the inward and outward movement of the working piston. The two pressure chambers of the piston-cylinder unit can be separately controlled with a pressure medium. The first pressure chamber of the piston-cylinder unit, which is bounded by the two pistons of the piston-cylinder unit, is preferably pneumatically controlled, while the second pressure chamber of the piston-cylinder unit is hydraulically controlled. The second pressure chamber, which is filled with a hydraulic pressure medium, is closed by a check valve in a pressure medium line and by a control valve in a back flow line, as soon as the releasing system fills the first pressure chamber with the corresponding operating pressure. During the rest phase of the clutch, a certain pressure will be maintained in the second pressure chamber of the piston-cylinder unit by way of an overflow valve in the hydraulic back flow line; the pressure corresponding to the resting force of a preloading spring. In this way, it is assured that a release bearing of the releasing system always abuts the contact spring of the clutch, which means that a preloading spring can be dispensed with. If wear occurs between a contact disk and the friction linings of the friction clutch, a force is exerted on the release bearing and thus an axial force on the piston-cylinder unit. The two pistons of the piston-cylinder unit will be displaced by this force in the direction of the transmission-side end of the cylinder, until the change in position of the contact spring of the friction clutch that is caused by wear, is compensated for. As soon as a new balance of forces has been established, the two pistons come to a standstill. Through the compensation for wear and tear, the final position of the second piston of the piston-cylinder unit is also displaced in the direction of the transmission-side end of the cylinder, such that there is an axial displacement of the piston stroke when there is a clutch release. Based on this new position of the two pistons, the working piston performs its inward and outward movement with the usual piston stroke, because the first pressure chamber of the piston-cylinder unit is always supplied with a constant pressure by way of the pressure generating device. With continuing operation of the release system, the pistons, due to increasing wear on the friction clutch, will be increasingly displaced in the direction of the transmission-side end of the cylinder. With maximum clutch wear, the second piston of the piston-cylinder unit reaches a final position on the transmission-side of the cylinder. In this position as well, the working piston performs the usual piston stroke.

### BRIEF DESCRIPTION OF THE DRAWING

The invention will now be described, by way of example, with reference to the accompanying drawing in which:

The sole FIGURE shows a release system for controlling a friction clutch in a motor vehicle.

### DETAILED DESCRIPTION OF THE INVENTION

A release system 1 for a friction clutch 2 in a motor vehicle shown in the FIGURE consists of a piston-cylinder unit 24 that is arranged concentrically to a transmission input shaft 12. The friction clutch 2 consists of a flywheel 3, a clutch housing 8, a clutch disk 4 that features two friction linings 5, 6 and a contact spring 10 that is connected, via spacer bolts 9, to a contact disk 7. The contact spring 10 can be configured as a membrane or plate spring and is in connection with a release bearing 11 of the release system 1. For a more exact description of the friction clutch 2, see the patent application publications DE 32 41 248 A1 and DE 197 03 333 B4. The piston-cylinder unit 24 features a cylinder 13 and a first piston 14 and a second piston 17, which delimit a first pressure chamber 16 and a second pressure chamber 19 of the piston-cylinder unit 24. The first piston 14 of piston-cylinder unit 24 serves as a working piston, where the second piston 17 of the cylinder-piston unit 24 represents a final position of the release system 1. In addition, the release system 1 features a hydraulic circuit, consisting of a pressure generating device 23, a pressure regulating means 21, a check valve 20, an overflow valve 27, a control valve 31, a pressure medium line 22, as well as a back flow line 26 and a container that serves as a pressure-medium sink 25. The devices already present in a transmission for supplying lubricants to the transmission can preferably be used as the pressure generating device 23 and the pressure medium sink 25. The pressure medium line 22 and the back flow line 26 are connected to the second pressure chamber 19 of the piston-cylinder unit 24, while the first pressure chamber 16 of the piston-cylinder unit 24 is connected to a further pressure medium line 29. The pressure medium line 29 is connected to a pneumatic pressure generating device 28, for example a pneumatic pump. The control valve 31 in the hydraulic circuit is connected to an additional pressure medium line 30, which is connected to the pneumatic pressure generating means 28. The first pressure chamber 16 of the piston-cylinder unit 24 can therefore be pneumatically controlled, while the second pressure chamber 19 of the piston-cylinder unit 24 is hydraulically controlled. Between the cylinder 13 and the first piston 14 of the piston-cylinder unit 24, at least one sealing means 15 can be arranged. At least one sealing means 18 can also be arranged between the cylinder 13 and the second piston 17 of the piston-cylinder unit 24. In order to operate the clutch, the first pressure chamber 16 of the piston-cylinder unit 24 is filled via the pneumatic pressure generating device 28 with a corresponding operating pressure. The second pressure chamber 19 of the piston-cylinder unit 24, which is filled with a hydraulic pressure medium, is closed during clutch operation by the check valve 20, which is arranged in the pressure medium line 22, and by a control valve 31 arranged in the back flow line 26. The control valve 31 in the hydraulic back flow line 26 is controlled by way of the pneumatic operating pressure that controls the clutch release, such that the back flow line 26, between the second pressure chamber 19 of the piston-cylinder unit 24 and the pressure medium sink 25, is interrupted. During the rest phase of the friction clutch 2, a specific pressure is maintained in the second pressure chamber 19 of the piston-cylinder unit 24 by way of an overflow valve 27 in the hydraulic back flow line 26. The pressure produces a rest force which corresponds to a rest force of a preloading spring. This ensures that the release bearing 11 abuts on the contact springs 10 of the clutch 2, which means that a preloading spring can be dispensed with. If wear occurs between the contact disk 7 and the friction linings 5, 6, the contact disk moves in the direction of the flywheel 3 and the position of the contact spring 10 changes. This produces a force on the release bearing 11, such that an axial force acts on the piston-cylinder unit 24. By way of this axial force, the pistons 14, 17 will be displaced to the right in the drawing plane, until the change in position of the contact spring 10 of the friction clutch 2, that is due to wear and tear, is compensated for. As soon as a new balance of forces has been established, the pistons 14, 17 come to a standstill. The final position of the release system 1, which is realized by the second piston 17 of the piston-cylinder unit 24, is also displaced to the right in the drawing plane, where there is an axial displacement of the piston stroke with a clutch release. Based on this new position of the pistons 14, 17, the first piston 14 of the piston-cylinder unit 24 performs its inward and outward movement with the usual piston stroke, because the first pressure chamber 16 of the piston-cylinder unit 24 can be supplied with a constant pressure via the pressure generating device 28. With continuing operation of the release system 1, the pistons 14, 17, due to increasing wear on the friction clutch 2, will be increasingly displaced more to the right in the drawing plane. With maximum clutch wear, the second piston 17 of the piston-cylinder unit 24 reaches a final position at the transmission-side end of the cylinder 13. In this position as well, the first piston 14 of the piston-cylinder unit 24 performs the usual piston stroke.

By way of the release system 1, the operating volume of the clutch release path remains constant during the entire lifetime. Since the piston-cylinder unit 24 has two pistons 14, 17, wear and tear on the friction clutch 2 can be automatically compensated for and clutch operation with a constant piston stroke can be carried out. In that way, the friction clutch 2 or the release system 1 demonstrates the same response during each operation, such that an equal short response time can be realized and maintained.

### REFERENCE NUMERALS

1 release system
2 friction clutch
3 flywheel mass
4 clutch disk
5 friction lining
6 friction lining
7 contact disk
8 clutch housing
9 spacer bolts
10 contact spring, membrane or plate spring
11 release bearing
12 transmission input shaft
13 cylinder
14 first piston or the piston-cylinder unit, working piston
15 sealing means
16 first pressure chamber of the piston-cylinder unit
17 second piston of the piston-cylinder unit
18 sealing means
19 second pressure chamber of the piston-cylinder unit
20 check valve
21 pressure regulating means, throttle
22 pressure medium line
23 pressure generating device
24 piston-cylinder unit
25 pressure medium sink
26 back flow line
27 overflow valve
28 pressure generating device
29 pressure medium line
30 pressure medium line
31 control valve

1-20. (canceled)

21. A releasing system (1) for at least one of a clutch and an accelerating coupling (2) in a motor vehicle, comprising a piston-cylinder unit (24) arranged concentrically to a transmission input shaft (12), which features a cylinder (13), whereby the releasing system (1) automatically compensates for wear and tear on the at least one of the clutch and the accelerating coupling (2), the piston-cylinder unit (24) comprises first and second pistons (14, 17) by which two pressure chambers (16, 19) in a cylinder (13) of the piston-cylinder unit (24) are bounded, which can be actuated separately by a pressure medium, and the at least one of the clutch and the accelerating coupling (2) is operated via the first piston (14) of the piston-cylinder unit (24), and the second piston (17) of the piston-cylinder unit (24), with maximum clutch wear, represents a final position on a transmission-side end of the cylinder (13).

22. The releasing system (1) according to claim 21, wherein a first pressure chamber (16) of the piston-cylinder unit (24) is pneumatically pressurized by a first pressure generating device (28).

23. The releasing system (1) according to claim 21, wherein a second pressure chamber (19) of the piston-cylinder unit (24) is hydraulically pressurized by a second pressure generating device (23).

24. The releasing system (1) according to claim 21, wherein a sealing means (15, 18) is arranged between the cylinder (13) and the first and the second pistons (14, 17).

25. The releasing system (1) according to claim 21, wherein the second pressure chamber (19) of the piston-cylinder unit (24) is connected, via a pressure medium line (22), to a second pressure generating device (23) and, via a back flow line (26), to a pressure medium sink (25).

26. The releasing system (1) according to claim 25, wherein the second pressure generating device (23) and the pressure medium sink (25) additionally supply lubricant to a transmission of the vehicle.

27. The releasing system (1) according to claim 25, wherein a check valve (20), a pressure regulating means (21), and the second pressure generating device (23) are arranged in the pressure medium line (22).

28. The releasing system (1) according to claim 25, wherein an overflow valve (27) and a control valve are arranged in the back flow line (26).

29. The releasing system (1) according to claim 21, wherein a first pressure generating device (28) is connected, via a pressure medium line (29), to the first pressure chamber (16) of the piston-cylinder unit (24) and, via a pressure medium line (30), to a control valve (31).

30. The releasing system (1) according to claim 21, wherein the at least one of the clutch and the accelerating coupling (2) is a friction clutch.

31. A method of controlling a releasing system (1) for at least one of a clutch and an accelerating coupling (2) in a motor vehicle comprising of a piston-cylinder unit (24) that is arranged concentrically to a transmission input shaft (12), whereby the releasing system (1) automatically compensates for clutch wear, first and second pistons (14, 17) of the piston-cylinder unit (24) delimit first and second pressure chambers (16, 19) that are controlled separately with a pressure medium; the at least one clutch and accelerating coupling is operated via the first piston (14) of the piston-cylinder unit (24), and via the second piston (17) of the piston-cylinder unit (24), a final position of the releasing system (1) is produced; the second pressure chamber (19) of the piston-cylinder unit (24) is closed by a check valve (20) in a pressure medium line (22) and by a control valve (31) in a back flow line (26) during clutch actuation, as soon as a corresponding operating pressure is applied to the first pressure chamber (16) of the piston-cylinder unit (24); and the second piston (17) of the piston-cylinder unit (24), with maximum clutch wear, reaches a final position on a transmission-side end of a cylinder (13).

32. The method according to claim 31, further comprising the step of pneumatically controlling the first pressure chamber (16) of the piston-cylinder unit (24) with a pressure generating device (28).

33. The method according to claim 31, further comprising the step of hydraulically controlling the second pressure chamber (19) of the piston-cylinder unit (24) with a pressure generating device (23).

34. The method according to claim 31, further comprising the step of maintaining a specific pressure in the second pressure chamber (19) of the piston-cylinder unit (24) with an overflow valve (27) in the back flow line (26) during a rest phase of the clutch.

35. The method according to claim 31, further comprising the step of retaining a constant operating volume for the piston stroke of the first piston (14) of the piston-cylinder unit (24) during an entire lifetime of the at least one clutch and accelerating coupling (2).

36. A clutch control system (1) that automatically compensates for clutch wear, the clutch control system (1) comprising:
a piston-cylinder unit (24) having a cylinder (13) in which first and second pistons (14, 17) slide, the piston-cylinder unit (24) being coaxial with a transmission input shaft (12), and the first piston (14) communicates with a clutch (2);
first and second pressure chambers (16, 19) being delimited within the cylinder (13) by the first and the second pistons (14, 17), the first pressure chamber (16) being located between the first and the second pistons (14, 17) and the second pressure chamber (19) being located between the second piston (17) and an end of the cylinder (13); and
a second pressure pump (23), a second pressure regulator (21) and a valve (20, 27, 31) communicate with the second pressure chamber (19) and a first pressure pump (28) communicates with the first pressure chamber (16) and the valve (31) such that the clutch (2) is controllably actuatable and an axial position of the second piston (18) is dependent on an amount of clutch wear, with abutment of the second piston (17) with the end of the cylinder (13) denoting a maximum amount of clutch wear.
